(19) United States
(12) Patent Application Publication
(10) Pub. No.: US 2020/0364386 A1
(43) Pub. Date: Nov. 19, 2020

(54) SOFT SENSING METHOD AND SYSTEM FOR DIFFICULT-TO-MEASURE PARAMETERS IN COMPLEX INDUSTRIAL PROCESSES

(71) Applicant: BEIJING UNIVERSITY OF TECHNOLOGY, Beijing (CN)

(72) Inventors: Jian TANG, Beijing (CN); Gang YU, Beijing (CN); Jianjun ZHAO, Beijing (CN); Meng WANG, Beijing (CN)

(21) Appl. No.: 16/812,629

(22) Filed: Mar. 9, 2020

(30) Foreign Application Priority Data
May 14, 2019 (CN) 201910397985.9

(51) Int. Cl. G06F 30/20

(52) U.S. Cl. CPC G06F 30/20; G06F 2111/10

(57) ABSTRACT

Disclosed is a soft sensing method for difficult-to-measure parameters in complex industrial processes. A linear selection of high-dimensional original features is performed using correlation coefficients, and several linear feature subsets are obtained based on a preset set of linear feature selection coefficients. A nonlinear selection of the original features is performed using mutual information, and several nonlinear feature subsets are obtained based on a preset set of nonlinear feature selection coefficients. Linear and nonlinear submodels are established based on the linear and nonlinear feature subsets, respectively, resulting in 4 submodel subsets including a linear submodel of linear features, a nonlinear submodel of linear features, a linear submodel of nonlinear features and a nonlinear submodel of nonlinear features. A SEN soft sensing model for difficult-to-measure parameters with better generalization performance is obtained by selecting and merging the candidate submodels based on an optimization selection and a weighting algorithm.

### CROSS-REFERENCE TO RELATED APPLICATIONS

This application claims the benefit of priority from Chinese Patent Application No. 201910397985.9, filed on May 14, 2019. The content of the aforementioned application, including any intervening amendments thereto, is incorporated herein by reference in its entirety.

### TECHNICAL FIELD

This application relates to soft sensing, and more particularly to a soft sensing method for difficult-to-measure parameters in complex industrial processes.

### BACKGROUND OF THE INVENTION

Generally, complex industrial processes, such as mineral grinding and municipal solid waste incineration, have comprehensive and complex characteristics of unclear mechanism, nonlinearity and strong coupling. Difficult-to-measure parameters relative to key process parameters for indicating running state, quality or efficiency of those processes (Operation Optimization and Feedback Control of Complex Industrial Processes, Chai T, ACTA AUTOMATICA SINICA, 2013, 39(11): 1744-1757). These parameters, such as mill load for characterizing grinding efficiency, can be estimated by excellent experts in production field by experience. Also, these parameters can be determined by combining manual timing sampling and offline analysis in laboratory, for example, this method can be used to determine grinding sizes for characterizing grinding quality, and dioxin concentrations for characterizing pollution emission indexes of municipal solid waste incineration processes. These methods for measuring difficult-to-measure parameters are imprecise and greatly lagging, which has become one of the main problems that restricts the operation optimization and feedback control of such complex industrial processes (Spectral Data Driven Soft Sensing of Load of Rotating Machinery Equipment, Tang J, et al., National Defense Industry Press, 2015). Therefore, such problem can be effectively solved by establishing a soft sensing model for those difficult-to-measure parameters based on process variables that are easy to measure offline with relative to production process mechanisms and experience (Data-driven Soft-sensors in the Process Industry, Kadlec P, et al., Computers and Chemical Engineering, 2009, 33(4): 795-814).

With the advancement of detection techniques in terms of image, infrared, vibration and audio, the soft sensing model for difficult-to-measure parameters have multi-source and multi-dimentional input features and a complicated mapping relationship between the input features and the difficult-to-measure parameters. In order to establish a soft-sensing model for difficult-to-measure parameters with interpretability and stronger generalization ability, it is an effective strategy to select high-dimensional input features. Feature selection algorithm can effectively remove “irrelevant features” and “redundant features” and ensure that important features are kept (Modeling Multi-component Mechanical Signals by Means of Virtual Sample Generation Techniques, Tang J, et al., ACTA AUTOMATICA SINICA, 2018, 44(9): 1569-1589).

For data of image, infrared, vibration, acoustic and other sensors, the transformed high-dimensional features have no obvious physical meanings, but the selection of feature subsets is more meaningful (Spectral Data Driven Soft Sensing of Load of Rotating Machinery Equipment, Tang J, et al., National Defense Industry Press, 2015). Similarly, differentiated combinations of process variables with physical meanings can also obtain soft sensing models with different predictive performance. Insufficient knowledge of mechanisms leads to difficulty in obtaining valid combinations of process variables, and introduction of multi-source features makes it more difficult to recognize the difficult-to-measure parameters. Besides, there are differences between mapping relations of different difficult-to-measure parameters and multi-source high-dimensional features.

A linear correlation feature can be selected based on a correlation coefficient between a single input feature and a difficult-to-measure parameter. For example, in Feature Selection in Cancer Microarray Data Using Multi-Objective Genetic Algorithm Combined with Correlation Coefficient, Hasnat A, et al., 2016 International Conference on Emerging Technological Trends (ICETT), IEEE, 2016: 1-6, features of microarray data are selected by combining multi-objective optimization algorithms and correlation coefficients; in Multi-Objective Semi-Supervised Feature Selection and Model Selection Based on Pearson Correlation Coefficient, Coelho F, et al., Iberoamerican Congress Conference on Pattern Recognition, Springer-Verlag, 2010, proposed is a multi-objective semi-supervised feature selection method based on correlation coefficients; in Significance of Entropy Correlation Coefficient over Symmetric Uncertainty on FAST Clustering Feature Selection Algorithm, Malji P, et al., 2017 11th International Conference on Intelligent Systems and Control (ISCO), IEEE, 2017: 457-463, proposed is a feature clustering method based on entropy correlation coefficients to quickly cluster feature subsets. Because of a disadvantage that linear methods based on correlation coefficients can hardly describe complex nonlinear mapping relationships, mutual information can effectively select nonlinear features related to the difficult-to-measure parameters (A Review of Feature Selection Methods Based on Mutual Information, Vergara J R, et al., Neural Computing and Applications, 2014, 24(1): 175-186, and Using Mutual Information for Selecting Features in Supervised Neural Net Learning, Battiti R, IEEE Transactions on Neural Networks, 1994, 5(4):537-550). For example, in Statistical Pattern Recognition: A Review, Jain A K, et al., IEEE Transactions on Pattern Analysis and Machine Intelligence, 2000, 22(1): 4-37, and Fast Binary Feature Selection with Conditional Mutual Information, Fleuret F, et al., Journal of Machine Learning Research, 2004, 5(Nov.): 1531-1555, proposed are feature selection methods based on individual optimal mutual information and conditional mutual information. For actual production processes, how to adaptively determine feature selection thresholds for efficient selection of linear and nonlinear feature subsets is an open problem to be solved.

After obtaining linear and nonlinear feature subsets containing different numbers of original features, it is also necessary to solve the problem of establishing soft sensing models for difficult-to-measure parameters. Generally, there is redundancy and complementarity between the above-mentioned linear and nonlinear feature subsets, and the linear or nonlinear models constructed based on these feature subsets also have different predictive performances for different difficult-to-measure parameters. Ensemble modeling improves the stability and robustness of prediction models by combining outputs of several heterogeneous or homogeneous submodels. The most concerned issue is how to improve the diversity among submodels. Diversity Creation Methods: A Survey and Categorisation, Brown G, et al., Information Fusion, 2005, 6(1): 5-20, indicates that the construction strategy for the diversity of submodels includes resampling training samples of sample space, and feature subset partitioning or feature transformation of feature space, where the construction strategy based on feature space has greater advantages. When facing multi-source features, Spectral Data Driven Soft Sensing of Load of Rotating Machinery Equipment, Tang J, et al., National Defense Industry Press, 2015, points out that soft sensing models constructed with a Selective Ensemble (SEN) learning mechanism have better performance. To deal with multi-source high-dimensional spectral data of a small sample, in Modeling Load Parameters of Ball Mill in Grinding Process Based on Selective Ensemble Multisensor Information, Tang J, et al., IEEE Transactions on Automation Science and Engineering, 2013, 10(3): 726-740, and A Comparative Study That Measures Ball Mill Load Parameters through Different Single-Scale and Multi-Scale Frequency Spectra-Based Approaches, Tang J, et al., IEEE Transactions on Industrial Informatics, 2016, 12(6): 2008-2019, proposed is a SEN latent structure mapping model based on selective fusion of sample space and feature space; in Vibration and Acoustic Frequency Spectra for Industrial Process Modeling Using Selective Fusion Multi-Condition Samples and Multi-Source Features, Tang, J, et al., Mechanical Systems and Signal Processing, 2018, 99: 142-168, provided is a double-layer SEN latent structure mapping model for multi-scale mechanical signals by sampling training samples in the feature space. These models are all established based on integration of homogeneous submodels, free of selection of linear or nonlinear feature subsets of original features. Therefore, for multi-source high-dimensional features, how to build sufficient linear or nonlinear submodels with difference based on feature subsets, optimize and select these submodels, and then build SEN soft sensing models with difficult-to-measure parameters is also a problem to be solved.

As can be seen from the above, for difficult-to-measure parameter modeling of multi-source high-dimensional features, there are two problems need to be solved: (1) how to select linear and nonlinear feature subsets; (2) how to effectively select feature subsets of submodels and build SEN models with high generalization performance. Thus, the invention provides a soft sensing method for difficult-to-measure parameters in complex industrial processes. First, a linear selection of high-dimensional original features is performed using a correlation coefficient method, and several linear feature subsets are obtained based on a preset set of linear feature selection coefficients. Next, a nonlinear selection of the high-dimensional original features is performed using a mutual information method, and several nonlinear feature subsets are obtained based on a preset set of nonlinear feature selection coefficients. Then, linear and nonlinear submodels are established based on the linear and nonlinear feature subsets, respectively, resulting in 4 types of submodel subsets consisting of a linear submodel subset of linear features, a nonlinear submodel subset of linear features, a linear submodel subset of nonlinear features and a nonlinear submodel subset of nonlinear features. Finally, a SEN soft sensing model for difficult-to-measure parameters with better generalization performance is obtained by selecting and merging the above-mentioned candidate submodels based on an optimization selection algorithm and a weighting algorithm. The validity of the invention is emulated proofed by establishing a soft sensing model for mill load parameters based on high-dimensional mechanical vibration spectrum data of a ball mill during a mineral grinding process.

### SUMMARY OF THE INVENTION

The invention provides a soft sensing method for difficult-to-measure parameters in complex industrial processes.

The soft sensing method comprises establishing a soft sensing model in a following modelling strategy comprising the following steps: for convenience, rewritting input data X of the soft sensing model as follows:

$$\begin{matrix}X = [ {\{ {x}_{n}^{1} \}}_{n = 1}^{N} , L , {\{ {x}_{n}^{p} \}}_{n = 1}^{N} , L , {\{ {x}_{n}^{P} \}}_{n = 1}^{N} ] \\ = [ {x}^{1} , L , {x}^{p} , L , {x}^{P} ] \\ = {\{ {x}^{p} \}}_{p = 1}^{P} ;\end{matrix} \qquad ( 1 )$$

wherein N and P are the number and dimension of modelling samples, respectively, that is, P is the number of high-dimensional features of the input data, x^{P} represents a pth input feature; accordingly, the difficult-to-measure parameters are output of the soft sensing model, expressed as y={yₙ}n ₙ₋₁^{N};

performing a modelling strategy for 4 modules comprising a linear feature selection module based on correlation coefficients, a nonlinear feature selection module based on mutual information, a candidate submodel establishment module and an ensemble submodel selection and merging module,

wherein {ξₗᵢₙ^{p}}ₚ₋₁^{P} represents correlation coefficients of all input features, ξₗᵢₙ^{p} represents a correlation coefficient of the pth input feature; {k_{linfea}^{j}^{ₗᵢₙ}}ⱼ_{_{lin−1}}^{J}^{ₗᵢₙ} represents a set of linear feature selection coefficients, k _{linfea}^{j}^{ₗᵢₙ} represents a jₗᵢₙth linear feature selection coefficient, Jₗᵢₙ represents the number of the linear feature selection coefficients, linear and nonlinear submodels of the linear features; θ_{linfea}^{j}^{ₗᵢₙ} represents a linear feature selection threshold determined based on the jₗᵢₙth linear feature selection coefficient k_{linfea}^{j}^{ₗᵢₙ}, {θ_{linfea}^{j}^{ₗᵢₙ}}ⱼ_{_{lin−}}^{J}^{ₗᵢₙ} represents a set of all linear feature selection thresholds; X_{linfea}^{j}^{ₗᵢₙ} represents a linear feature subset selected based on the jₗᵢₙth linear feature selection threshold θ_{linfea}^{j}^{ₗᵢₙ}, {X_{linfea}^{j}^{ₗᵢₙ}}ⱼ_{_{lin−}}^{J}^{ₗᵢₙ} represents a set of all linear feature subsets; {ξₙₒₙₗᵢₙ^{p}}ₚ₋₁^{P} represents mutual information of all original features, ξₙₒₙₗᵢₙ^{P} represents mutual information of the pth input feature; {k_{nonlinfea}^{j}^{ₙₒₙₗᵢₙ}}ⱼ_{_{nonlin−1}}^{J}^{ₙₒₙₗᵢₙ} represents a set of nonlinear feature selection coefficients, k_{nonlinfea}^{j}^{ₙₒₙₗᵢₙ} represents a jₙₒₙₗᵢₙth nonlinear feature selection coefficient; Jₙₒₙₗᵢₙ represents the number of the nonlinear feature selection coefficients, linear and nonlinear submodels of the nonlinear features; θ_{nonlinfea}^{j}^{ₙₒₙₗᵢₙ} represents a nonlinear feature selection threshold determined based on the jₙₒₙₗᵢₙth nonlinear feature selection coefficient k_{nonlinfea}^{j}^{ₙₒₙₗᵢₙ} {θ_{nonlinfea}^{j}^{ₙₒₙₗᵢₙ}}ⱼ_{_{nonlin−a}}^{J}^{ₙₒₙₗᵢₙ} represents a set of all nonlinear feature selection thresholds; X_{nonlinfea}^{j}^{ₙₒₙₗᵢₙ} represents a nonlinear feature subset selected based on the jₙₒₙₗᵢₙth nonlinear feature selection threshold θ_{nonlinfea}^{j}^{ₙₒₙₗᵢₙ}, {X_{nonlinfea}^{j}^{ₙₒₙₗᵢₙ}}ⱼ_{_{nonlin−1}}^{J}^{ₙₒₙₗᵢₙ} represents a set of all nonlinear feature subsets; {f_{linMod}^{j}^{ₗᵢₙ}(⋅)}ⱼ_{ₗᵢₙ}₋₁^{J}^{ₗᵢₙ} and {ŷ_{linMod}^{j}^{ₗᵢₙ}}ⱼ_{ₗᵢₙ}₋₁^{J}^{ₗᵢₙ} represent a linear submodel subset of linear features and predictive outputs thereof, respectively, f_{linMod}^{j}^{ₗᵢₙ}(⋅) and ŷ_{linMod}^{j}^{ₗᵢₙ} represent a linear submodel of the jₗᵢₙth linear feature and a predictive output thereof, respectively; If {f_{nonlinMod}^{j}^{ₗᵢₙ}(⋅)}ⱼ_{ₗᵢₙ}₌₁^{J}^{ₗᵢₙ} and ŷ_{linMod}^{j}^{ₗᵢₙ} represent a nonlinear submodel subset of linear features and predictive outputs thereof, respectively, f_{nonlinMod}^{j}^{ₗᵢₙ}(⋅) and ŷ_{nonlinMod}^{j}^{ₗᵢₙ} represent a nonlinear submodel of the jₗᵢₙth linear feature and a predictive output thereof, respectively; {f_{linMod}^{j}^{ₙₒₙₗᵢₙ}(⋅)}ⱼ_{ₙₒₙₗᵢₙ}₌₁^{J}^{ₙₒₙₗᵢₙ} and {ŷ_{linMod}^{j}^{ₙₒₙₗᵢₙ}}ⱼ_{ₗᵢₙ}₌₁^{J}^{ₗᵢₙ} represent a linear submodel subset of nonlinear features and predictive outputs thereof, respectively, f_{linMod}^{j}^{ₙₒₙₗᵢₙ}(⋅) and ŷ_{linMod}^{j}^{ₙₒₙₗᵢₙ} represent a linear submodel of the jₙₒₙₗᵢₙth nonlinear feature and a predictive output thereof, respectively; {f_{nonlinMod}^{j}^{ₙₒₙₗᵢₙ}(⋅)}ⱼ_{ₙₒₙₗᵢₙ}₌₁^{J}^{ₙₒₙₗᵢₙ} and {ŷ_{nonlinMod}^{j}^{ₙₒₙₗᵢₙ}}ⱼ_{ₙₒₙₗᵢₙ}₌₁^{J}^{ₙₒₙₗᵢₙ} represent a nonlinear submodel subset of nonlinear features and predictive outputs thereof, respectively f_{nonlinMod}^{j}^{ₙₒₙₗᵢₙ}(⋅) and ŷ_{nonlinMod}^{j}^{ₙₒₙₗᵢₙ} represent a nonlinear submodel of the jₙₒₙₗᵢₙth nonlinear feature and a predictive output thereof, respectively; {ŷ_{can}^{j}}ⱼ₌₁^{J} represents outputs of all candidate submodels, ŷ_{can}^{j} represents an output of a jₙₒₙₗᵢₙth candidate submodel, J represents the number of all candidate submodels; {yₛₑₗ^{j}^{ₛₑₗ}}ⱼ_{ₛₑₗ}₌₁^{J}^{ₛₑₗ} represents outputs of all integrated submodels, ŷₛₑₗ^{j}^{ₛₑₗ} represents an output of a jₛₑₗth integrated submodel, Jₛₑₗ represents the number of all integrated submodels; ŷ represents predictions of the difficult-to-measure parameters.

The 4 modules respectively have the following functions:

(1) the linear feature selection module based on correlation coefficients obtains the linear feature subsets with reference to the correlation coefficients based on prior knowledge and data characteristics;

(2) the nonlinear feature selection module based on mutual information obtains the nonlinear feature subsets with reference to the mutual information based on prior knowledge and data characteristics;

(3) the candidate submodel establishment module establishes 4 submodel subsets comprising a linear submodel subset of linear features, a nonlinear submodel subset of linear features, a linear submodel subset of nonlinear features and a nonlinear submodel subset of nonlinear features by using the linear and nonlinear feature subsets; and

(4) the ensemble submodel selection and merging module establishes an output set of the candidate submodels, obtains integrated submodels by an optimization selection and calculating outputs thereof, and finally obtaining a soft sensing model for the difficult-to-measure parameters.

The invention further adopts a modelling algorithm comprising:

(1) linear feature selection based on correlation coefficients

calculating an absolute value of correlation coefficients of the high-dimensional features of the input data by taking a pth input feature x^{p}={xₙ^{p}}ₙ₌₁^{N} as an example according to the following equation:

$${ξ}_{lin}^{p} = \vert \frac{{\sum }_{n = 1}^{N} [ ( {x}_{n}^{p} - {\overline{x}}_{p} ) ( {y}_{n} - \overline{y} ) ]}{\sqrt{{\sum }_{n = 1}^{N} {( {x}_{n}^{p} - {\overline{x}}_{p} )}^{2}} \sqrt{{\sum }_{n = 1}^{N} {( {y}_{n} - \overline{y} )}^{2}}} \vert ; \qquad ( 2 )$$

wherein x̅ₚ and y̅ represent an average of N modelling samples of the pth input feature and the difficult-to-measure parameters, respectively; ξₗᵢₙ^{p} represents correlation coefficient of the pth input feature;

repeating the above calculation to obtain the correlation coefficients {ξₗᵢₙ^{p}}ₚ₌₁^{P} of all input features;

determining the linear feature selection threshold θ_{linfea}^{j}^{ₗᵢₙ} based on the jₗᵢₙth linear feature selection coefficient k_{linfea}^{j}^{ₗᵢₙ} according to the following equation:

$${θ}_{linfea}^{{j}_{lin}} = {k}_{linfea}^{{j}_{lin}} \cdot \frac{1}{P} {\sum }_{p = 1}^{P} {ξ}_{lin}^{p} ; \qquad ( 3 )$$

adaptively determining Jₗᵢₙ linear feature selection coefficients based on characteristics of the input data according to the following equation:

k_{linfea}^{j}^{ₗᵢₙ}=k_{linfea}^{min}:k_{linfea}^{step}:k_{linfea}^{max} (4);

wherein k_{linfea}^{min} and k_{linfea}^{max} represent a minimum and a maximum of k_{linfea}^{j}^{ₗᵢₙ} , respectively, and are calculated according to the following equations:

$$\begin{matrix}{k}_{linfea}^{min} = min ( {\{ {ξ}_{lin}^{p} \}}_{p = 1}^{P} ) / \frac{1}{P} {\sum }_{p = 1}^{P} {ξ}_{lin}^{p} ; & ( 5 ) \\ {k}_{linfea}^{max} = max ( {\{ {ξ}_{lin}^{p} \}}_{p = 1}^{P} ) / \frac{1}{P} {\sum }_{p = 1}^{P} {ξ}_{lin}^{p} ; & ( 6 )\end{matrix}$$

wherein min(⋅)and max(⋅)represent a minimum and a maximum, respectively; when k_{linfea}^{j}^{ₗᵢₙ} is 1, the linear feature selection threshold θ_{linfea}^{j}^{ₗᵢₙ} is an average;

k_{linfea}^{step} represents a step size of Jₗᵢₙ feature selection coefficients, and is calculated according to the following equation:

$${k}_{linfea}^{s t e p} = \frac{{k}_{linfea}^{max} - {k}_{linfea}^{min}}{{J}_{lin}} ; \qquad ( 7 )$$

selecting the input data by taking the pth input feature as an example based on the linear feature selection threshold θ_{linfea}^{j}^{ₗᵢₙ} according to the following equation:

$${α}_{{j}_{lin}}^{p} = \{ \begin{matrix}1 , & if {ξ}_{l i n}^{p} \geq {θ}_{linfea}^{{j}_{lin}} \\ 0 , & else {ξ}_{l i n}^{p} < {θ}_{linfea}^{{j}_{lin}}\end{matrix} ; \qquad ( 8 )$$

selecting variables when αⱼ_{ₗᵢₙ}^{p}=1 as linear features selected based on the linear feature selection threshold θ_{linfea}^{j}^{ₗᵢₙ}, preforming the above steps on all input features to obtain a linear feature subset X_{linfea}^{j}^{ₗᵢₙ}, indicated as follows:

X_{linfea}^{j}^{ₗᵢₙ}=[x¹,L , x^{p}^{^{j}}^{ₗᵢₙ}^{linfea},L ,x^{p}^{^{jlin}}^{linfea}] (9);

wherein x^{p}^{^{jlin}}^{linfea} represents a p_{linfea}^{jlin} feature in the linear feature subset X_{linfea}^{j}^{ₗᵢₙ}, p_{linfea}^{jlin}=1,L , P_{linfea}^{j}^{ₗᵢₙ} and P_{linfea}^{j}^{ₗᵢₙ} represent the number of all features in the linear feature subset X_{linfea}^{j}^{ₗᵢₙ};

indicating a set of all Jₗᵢₙ linear feature subsets as {X_{linfea}^{j}^{ₗᵢₙ}}ⱼ_{ₗᵢₙ₌₁}^{J}^{ₗᵢₙ};

(2) nonlinear feature selection based on mutual information

data by taking the pth input feature x^{p}={xₙ^{p}}ₙ₌₁^{N} as an example according to the following equation:

$${ξ}_{nonlin}^{p} = {\sum }_{n = 1}^{N} {\sum }_{n = 1}^{N} {p}_{r o b} ( {x}_{n}^{p} , {y}_{n} ) log ( \frac{{p}_{r o b} ( {x}_{n}^{p} , {y}_{n} )}{{p}_{r o b} ( {x}_{n}^{p} ) {p}_{rob} ( {y}_{n} )} ) ; \qquad ( 10 )$$

wherein p_{rob}(xₙ^{p}, yₙ) represents a joint probability density, p_{rob}(xₙ^{p}) and p_{rob}(yₙ) represent marginal probability densities;

obtaining the mutual information {ξₙₒₙₗᵢₙ^{p}}ₚ₌₁^{P} of all input features by repeating the above calculation;

determining the nonlinear feature selection threshold θ_{nonlinfea}^{j}^{ₙₒₙₗᵢₙ} based on the jₙₒₙₗᵢₙth nonlinear feature selection coefficient k_{nonlinfea}^{j}^{ₙₒₙₗᵢₙ} according to the following equation:

$${θ}_{nonlinfea}^{{j}_{nonlin}} = {k}_{nonlinfea}^{{j}_{nonlin}} \cdot \frac{1}{P} {\sum }_{p = 1}^{P} {ξ}_{n o n l i n}^{p} ; \qquad ( 11 )$$

adaptively determining Jₙₒₙₗᵢₙ nonlinear feature selection coefficients based on characteristics of the input data according to the following equation:

k_{linfea}^{j}^{ₙₒₙₗᵢₙ}=k_{linfea}^{min}:k_{linfea}^{step}:k_{linfea}^{max} (12);

wherein k_{nonlinfea}^{min} and k_{nonlinfea}^{max} represent a minimum and a maximum of k_{linlinfea}^{j}^{ₙₒₙₗᵢₙ}, respectively, and are calculated according to the following equations:

$$\begin{matrix}{k}_{nonlinfea}^{min} = min ( {\{ {ξ}_{nonlin}^{p} \}}_{p = 1}^{P} ) / \frac{1}{P} {\sum }_{p = 1}^{P} {ξ}_{nonlin}^{p} ; & ( 13 ) \\ {k}_{nonlinfea}^{max} = max ( {\{ {ξ}_{nonlin}^{p} \}}_{p = 1}^{P} ) / \frac{1}{P} {\sum }_{p = 1}^{P} {ξ}_{nonlin}^{p} ; & ( 14 )\end{matrix}$$

wherein when k_{linlinfea}^{j}^{ₙₒₙₗᵢₙ} the nonlinear feature selection threshold θ_{nonlinfea}^{j}^{ₙₒₙₗᵢₙ} is an average;

k_{linfea}^{step} represents a step size of Jₙₒₙₗᵢₙ feature selection coefficients, and is calculated according to the following equation:

$${k}_{nonlinfea}^{s t e p} = \frac{{k}_{nonlinfea}^{max} - {k}_{nonlinfea}^{min}}{{J}_{nonlin}} ; \qquad ( 15 )$$

selecting the input data by taking the pth input feature as an example based on the nonlinear feature selection threshold θ_{nonlinfea}^{j}^{ₙₒₙₗᵢₙ} according to the following equation:

$${α}_{{j}_{nonlin}}^{p} = \{ \begin{matrix}1 , & if {ξ}_{nonlin}^{p} \geq {θ}_{nonlinfea}^{{j}_{nonlin}} \\ 0 , & else {ξ}_{nonlin}^{p} < {θ}_{nonlinfea}^{{j}_{nonlin}}\end{matrix} ; \qquad ( 16 )$$

selecting variables when a ⱼ_{ₙₒₙₗᵢₙ}^{p}=1 as nonlinear features selected based on the nonlinear feature selection threshold θ_{nonlinfea}^{j}^{ₙₒₙₗᵢₙ}, preforming the above steps on all input features to obtain a nonlinear feature subset X_{nonlinfea}^{j}^{ₙₒₙₗᵢₙ}, indicated as follows:

X_{nonlinfea}^{j}^{ₙₒₙₗᵢₙ}=[x¹,L , x^{p}^{^{jnonlin}}^{nonlinfea},L ,x^{Pnonlinfea}^{^{jnonlin}}] (17);

wherein x^{pnonlinfea}^{^{jnonlin}} represents a p_{nonlinfea}^{j}^{ₙₒₙₗᵢₙ} feature in the nonlinear feature subset X_{nonlinfea}^{j}^{ₙₒₙₗᵢₙ}, p_{nonlinfea}^{j}^{ₙₒₙₗᵢₙ}=1,L ,P_{nonlinfea}^{j}^{ₙₒₙₗᵢₙ} and P_{nonlinfea}^{j}^{ₙₒₙₗᵢₙ} represent the number of all features in the nonlinear feature subset X_{nonlinfea}^{j}^{ₙₒₙₗᵢₙ};

indicating a set of all ^{J}ₙₒₙₗᵢₙ nonlinear feature subsets as {X_{nonlinfea}^{j}^{ₙₒₙₗᵢₙ}}ⱼ_{ₙₒₙₗᵢₙ₌₁}^{J}^{ₙₒₙₗᵢₙ};

(3) candidate submodel establishment

when establishing linear submodels of linear features using a linear modelling algorithm based on jₗᵢₙth linear feature subset, indicating inputs and outputs thereof as the following equation:

ŷ_{linMod}^{j}^{ₗᵢₙ}=f_{linMod}^{j}^{ₗᵢₙ}(X_{linfea}^{j}^{ₗᵢₙ}) (18);

performing the above step on all linear feature subsets to obtain the linear submodel subset of linear features {f_{linMod}^{j}^{ₗᵢₙ}(⋅)}ⱼ_{ₗᵢₙ}₌₁^{J}^{ₗᵢₙ} and the predictive outputs {ŷ_{linMod}^{j}^{ₗᵢₙ}}ⱼ_{ₗᵢₙ}₌₁^{J}^{ₗᵢₙ} thereof;

similarly, when establishing nonlinear submodels of linear features using a nonlinear modelling algorithm based on jₗᵢₙth linear feature subset, indicating inputs and outputs thereof as the following equation:

ŷ_{nonlinMod}^{j}^{ₗᵢₙ}=f_{nonlinMod}^{j}^{ₗᵢₙ}(X_{linfea}^{j}^{ₗᵢₙ}) (19);

performing the above step on all linear feature subsets to obtain the nonlinear submodel subset of linear features {f_{nonlinMod}^{j}^{ₗᵢₙ}(⋅)}ⱼ_{ₗᵢₙ}₌₁^{J}^{ₗᵢₙ} and the predictive outputs {y_{nonlinMod}^{j}^{ₗᵢₙ}}ⱼ_{ₗᵢₙ}₌₁^{J}^{ₗᵢₙ} thereof;

wherein the two above submodel subsets adopt the same linear features as inputs and obtain different predictive outputs using different modelling algorithms;

when establishing linear submodels of nonlinear features using a linear modelling algorithm based on iₙₒₙₗᵢₙth nonlinear feature subset, indicating inputs and outputs thereof as the following equation:

ŷ_{linMod}^{j}^{ₙₒₙₗᵢₙ}=f_{linMod}^{j}^{ₙₒₙₗᵢₙ}(X_{nonlinfea}^{j}^{ₙₒₙₗᵢₙ}) (20);

performing the above step on all nonlinear feature subsets to obtain the linear submodel subset of nonlinear features {f_{linMod}^{j}^{ₙₒₙₗᵢₙ}(⋅)}ⱼ_{ₙₒₙₗᵢₙ}₌₁^{J}^{ₙₒₙₗᵢₙ} and the predictive outputs {ŷ_{linMod}^{j}^{ₙₒₙₗᵢₙ}}ⱼ_{ₙₒₙₗᵢₙ}₌₁^{J}^{ₙₒₙₗᵢₙ} thereof;

similarly, when establishing nonlinear submodels of nonlinear features using a nonlinear modelling algorithm based on jₙₒₙₗᵢₙth nonlinear feature subset, indicating inputs and outputs thereof as the following equation:

ŷ_{nonlinMod}^{j}^{ₙₒₙₗᵢₙ}=f_{nonlinMod}^{j}^{ₙₒₙₗᵢₙ}(X_{nonlinfea}^{j}^{ₙₒₙₗᵢₙ}) (21);

performing the above step on all nonlinear feature subsets to obtain the nonlinear submodel subset of nonlinear features {f_{nonlinMod}^{j}^{ₙₒₙₗᵢₙ}(⋅)}ⱼ_{ₙₒₙₗᵢₙ}₌₁^{J}^{_{nonlin 1}} and the predictive outputs {ŷ_{nonlinMod}^{j}^{ₙₒₙₗᵢₙ}}ⱼ_{ₙₒₙₗᵢₙ}₌₁^{J}^{ₙₒₙₗᵢₙ} thereof;

wherein the two above submodel subsets adopt the same nonlinear features as inputs and obtain different predictive outputs using different modelling algorithms;

(4) ensemble submodel selection and merging

merging the predictive outputs of the 4 submodels according to the following equation:

{ŷ_{can}^{j}}ⱼ₌₁^{J}=[{ŷ_{linMod}^{j}^{ₗᵢₙ}}ⱼ_{ₗᵢₙ}₌₁^{J}^{ₗᵢₙ}, {ŷ_{nonlinMod}^{j}^{ₗᵢₙ}}ⱼ_{ₗᵢₙ}₌₁^{J}^{ₗᵢₙ}, {ŷ_{linMod}^{j}^{ₙₒₙₗᵢₙ}}ⱼ_{ₙₒₙₗᵢₙ}₌₁^{J}^{ₙₒₙₗᵢₙ}, {ŷ_{nonlinMod}^{j}^{ₙₒₙₗᵢₙ}}ⱼ_{ₙₒₙₗᵢₙ}₌₁^{J}^{ₙₒₙₗᵢₙ}] (22);

wherein J=2Jₗᵢₙ+2Jₙₒₙₗᵢₙ, J is the number of all 4 submodels and also the number of candidate submodels;

selecting predictive outputs of Jₛₑₗ ensemble submodels from predictive outputs of J candidate submodels using an optimization algorithm, and obtaining outputs of a final SEN prediction model by merging the predictive outputs of Jₛₑₗ ensemble submodels according to a selected merging algorithm:

$$\{ \begin{matrix}\hat{y} = {f}_{SEN} ( {\{ {\hat{y}}^{{j}_{sel}} \}}_{{j}_{sel} = 1}^{{J}_{sel}} ) \\ {\{ {\hat{y}}^{{j}_{sel}} \}}_{{j}_{sel} = 1}^{{J}_{sel}} ∈ {\{ {\hat{y}}^{j} \}}_{j = 1}^{J}\end{matrix} ; \qquad ( 23 )$$

wherein f_{SEN}(⋅) is an algorithm for merging the predictive outputs of Jₛₑₗ ensemble submodels, Jₛₑₗ is also an ensemble size of selective ensemble models;

to solve the above problem, first selecting the merging algorithm for predictive outputs of ensemble submodels, then optimizing Jₛₑₗ ensemble submodels using an optimization algorithm based on a root mean square error RMSE of minimizing the SEN model, and merging these ensemble submodels to finally obtain the SEN prediction model with the ensemble size of Jₛₑₗ;

wherein the algorithm f_{SEN}(⋅) for merging the predictive outputs of Jₛₑₗ ensemble submodels comprises the following 2 types:

a first type which calculates weighting coefficients, that is, obtains SEN output according to the following equation:

$$\hat{y} = {f}_{S E N} ( {\{ {\hat{y}}^{{j}_{sel}} \}}_{{j}_{sel} = 1}^{{J}_{sel}} ) = {\sum }_{{j}_{sel} = 1}^{{J}_{sel}} {w}^{{j}_{sel}} {\hat{y}}^{{j}_{sel}} ; \qquad ( 24 )$$

wherein w^{j}^{ₛₑₗ} represents weighting coefficient of a jₛₑₗth ensemble submodel, and

$${\sum }_{{j}_{sel}}^{{J}_{sel}} {w}^{{j}_{sel}} = 1 ;$$

wherein the weighting coefficients can be calculated by the following methods:

(1) simple averaging:

$${w}^{{j}_{sel}} = \frac{1}{{J}_{sel}} ; \qquad ( 25 )$$

(2) adaptive weighted fusion:

$${w}^{{j}_{sel}} = \frac{1}{{( {σ}^{{j}_{sel}} )}^{2} {\sum }_{{j}_{sel} = 1}^{{J}_{sel}} \frac{1}{{( {σ}^{{j}_{sel}} )}^{2}}} ; \qquad ( 26 )$$

wherein ρ^{j}^{ₛₑₗ} is a standard deviation of the predictive output ŷ^{j}^{ₛₑₗ} of the jₛₑₗth ensemble submodel;

(3) error information entropy weighting method

$${w}^{{j}_{sel}} = \frac{1}{{J}_{sel} - 1} ( 1 - ( 1 - {E}^{{j}_{sel}} ) / {\sum }_{{j}_{sel} = 1}^{{J}_{sel}} ( 1 - {E}^{{j}_{sel}} ) ) ; \qquad ( 27 )$$

wherein,

$$\begin{matrix}{E}^{{j}_{sel}} = \frac{1}{ln N} {\sum }_{n = 1}^{N} ( {( {e}^{{j}_{sel}} )}^{n} / {\sum }_{n = 1}^{N} {( {e}^{{j}_{sel}} )}^{n} ) ln ( {( {e}^{{j}_{sel}} )}^{n} / {\sum }_{n = 1}^{N} {( {e}^{{j}_{sel}} )}^{n} ) ; & ( 28 ) \\ {( {e}^{{j}_{sel}} )}^{n} = \{ \begin{matrix}( {( {\hat{y}}^{{j}_{sel}} )}^{n} - {y}^{n} ) / {y}^{n} & 0 \leq \vert ( {( {\hat{y}}^{{j}_{sel}} )}^{n} - {y}^{n} ) / {y}^{n} \vert < 1 \\ 1 & 1 \leq \vert ( {( {\hat{y}}^{{j}_{sel}} )}^{n} - {y}^{n} ) / {y}^{n} \vert\end{matrix} ; & ( 29 )\end{matrix}$$

wherein (ŷ^{j}^{ₛₑₗ})ⁿ represents a predictive output of the jₛₑₗth ensemble submodel to a nth sample; (e^{j}^{ₛₑₗ})ⁿ represents a relative prediction error of the nth sample after a preprocessing; E^{j}^{ₛₑₗ} represents a prediction error information entropy for the jₛₑₗth ensemble submodel;

a second type which establishes a mapping relation between the ensemble submodels and the SEN model using linear and nonlinear regression modelling methods, that is, establishes f_{SEN}(⋅) using algorithms such as partial least squares, neural networks and support vector machines; the optimization algorithm for selecting Jₛₑₗ ensemble submodels from J candidate submodels comprises branch-and-bound, genetic algorithm, particle swarm optimization and differential evolution.

### BRIEF DESCRIPTION OF THE DRAWINGS

FIG. 1 schematically shows a modelling strategy of a soft sensing method for difficult-to-measure parameters in complex industrial processes of the invention.

FIG. 2 schematically shows a grinding process circuit of the invention. FIG. 3 is a schematic diagram of a soft sensing system for loading parameters of a mill of the invention.

FIG. 4 schematically shows correlation coefficients and mutual information of spectrum features and MBVR.

FIG. 5 schematically shows prediction errors of different MBVR submodels when the correlation coefficients are 1.

FIG. 6 schematically shows prediction errors of different MBVR submodels when the correlation coefficients are 1.5.

### DETAILED DESCRIPTION OF EMBODIMENTS

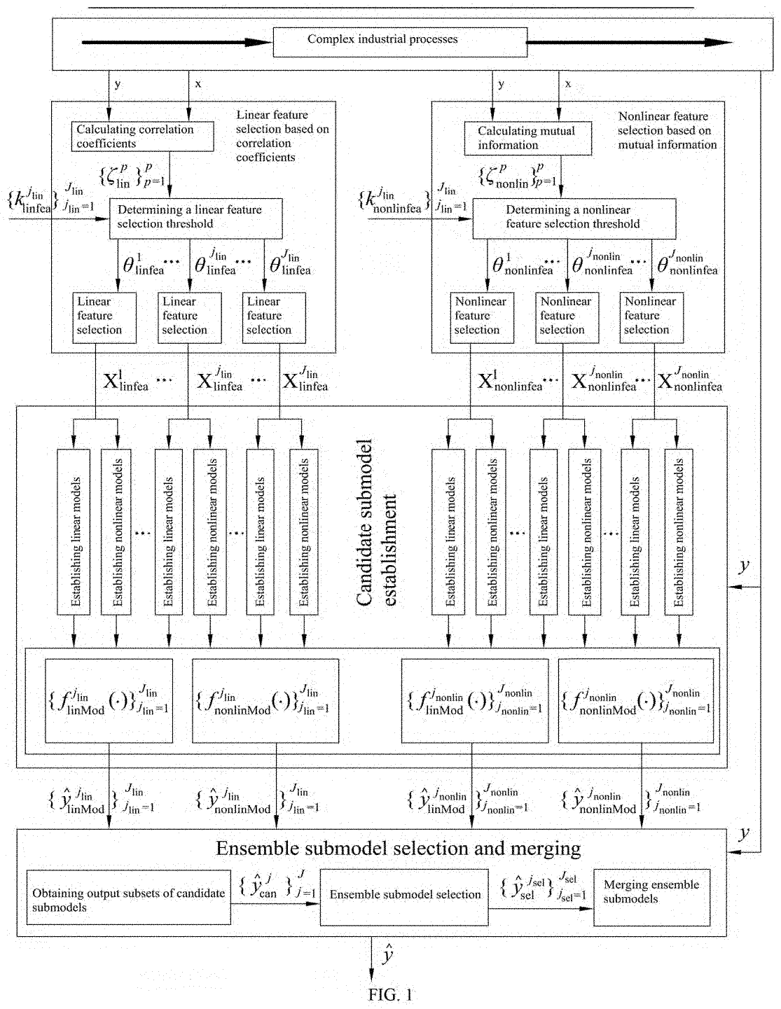

The invention is applied to measuring loading parameters of a mill using a modelling strategy shown in FIG. 1. The experimental data are obtained in the following steps.

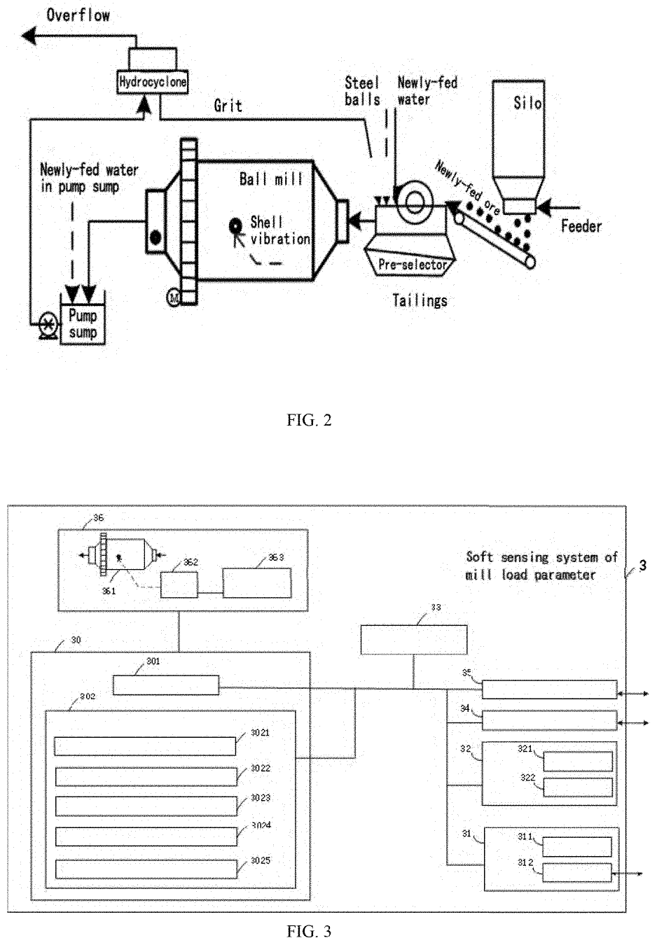

As shown in FIG. 2, ore dressing plants in China often employ a two-stage grinding circuit (GC), which usually includes a silo, a feeder, a wet pre-selector, a mill and a pump sump, sequentially connected. A hydrocyclone is connected between the pump sump and the wet pre-selector, so that a coarser-grained part is returned to the mill as an underflow for regrinding. Newly-fed ore and water and periodic addition of steel balls enter the mill (usually a ball mill) together with the underflow of the hydrocyclone. In the mill, the ore is impacted and grinded into finer particles by the steel balls, and is mixed with water in the mill, forming a pulp continuously flowing out of the mill and entering the pump sump. Fresh water is poured into the pump sump to dilute the pulp, which is injected into the hydrocyclone at a certain pressure. Then the pulp pumped into the hydrocyclone is separated into two parts: the coarse-grained part entering the mill as the underflow for regrinding; a remaining part entering a second stage grinding (GC II).

Meanwhile, in order to perform a soft sensing for the load parameters of the mill, a shell vibration signal acquisition device is combined with the mill to obtain shell vibration signals.

Grinding productivity (that is, grinding output) is usually obtained by maximally optimizing a cyclic load, which is often determined by the load of the grinding circuit. Overload of the mill will lead to spitting materials of the mill, coarser granules of the mill outlet materials, blockages of the mill, and even suspension of the grinding process. Underload of the mill will cause the mill to smash incompletely, resulting in waste of energy, increased loss of the steel balls, and even a mill damage. Therefore, the mill load is a very important parameter. Accurate measurement of internal load parameters of the ball mill is closely related to the product quality, production efficiency and safety of the production process during the grinding process. In the industrial field, experts mostly rely on multi-source information and their own experience to monitor the load status of the mill. A data-driven soft-sensing method based on the shell vibration signals and acoustic signals of the mill is often used to overcome subjectivity and instability caused by the inference of the mill load by the experts.

Mill load parameters include material to ball volume ratio (MBVR), pulp density (PD) and charge volume ratio (CVR), which are related to mill load and mill load status. In fact, there are tens of thousands of steel balls in the mill, which are arranged in layers and fall simultaneously with different impact forces. Vibrations caused by these impact forces with different frequency and amplitude are superimposed on each other. Mass imbalance of the mill and installation offset of the ball mill can also cause a mill cylinder to vibrate. These vibration signals are coupled to each other to form a measurable shell vibration signal. Generally, these mechanical signals have significant unsteady state and are multi-component, and features of the mechanical signals are difficult to extract in the time domain, according to Tool Wear State Recognition Based on Improved Emd and Ls-Svm, Nie P, et al., Journal of Beijing University of Technology, 2013, 39(12):1784-1790. Signal processing technique is usually used for preprocessing to extract more significant features, according to Machine Fault Feature Extraction Based on Intrinsic Mode Functions, Fan X, et al., Measurement Science & Technology, 2008, 19: 334-340; and Fault Diagnosis Method of Rolling Bearings Based on Teager Energy Operator and EEMD, Journal of Beijing University of Technology, 2017, 43(6): 859-864. Fast Fourier transform is the most commonly used method. Selective Ensemble Modeling Load Parameters of Ball Mill Based on Multi-Scale Frequency Spectral Features and Sphere Criterion, Tang J, et al., Mechanical Systems & Signal Processing, 2016, 66-67: 485-504 refers to spectrum obtained based on the fast Fourier transform as single-scale spectrum.

The method is verified by modelling for mill load parameters of an experimental ball mill based on a single-scale high-dimensional shell vibration spectrum. This experiment is performed on a small experimental mill with a diameter of 602 mm and a length of 715 mm, where a mill cylinder has a rotation speed of 42 r/min. In the experiment, a soft sensing system 3 for the mill load parameters is shown in FIG. 3.

The soft sensing system 3 includes a data collection unit 36 on the mill, a processing unit 30, a storage medium 33, an input or output interface 35, a wired or wireless network interface 34, an output unit 32 and an acquisition unit 31.

The data collection section 36 on the mill includes a vibrating sensor 362 and a wireless data transmitting device 363 mounted on a ball mill 361, and is configured to collect a vibration acceleration of the mill cylinder based on a sampling frequency of 51,200 Hz, and send the vibration acceleration of the mill cylinder wirelessly.

The processing unit 30 including a storage 301 and a processor 302 is wirelessly connected to the data collection unit 36 on the mill. The processor 302 includes a wireless data receiving and preprocessing module 3021 under the mill, a linear feature selection module 3022 based on correlation coefficients, a nonlinear feature selection module 3023 based on mutual information, candidate submodel establishing module 3024, ensemble submodel selection and merging module 3025, where the wireless data receiving and preprocessing module 3021 under the mill is configured to receive shell vibration signals transmitted through the wireless network, and perform filtering and FFT transformation to obtain spectrum data; the linear feature selection module 3022 based on correlation coefficients is configured to calculate the correlation coefficients between the shell vibration spectrum and the mill load parameters; the nonlinear feature selection module 3023 based on mutual information is configured to calculate the mutual information between the shell vibration spectrum and the mill load parameters; the candidate submodel establishing module 3024 is configured to establish candidate submodels based on different feature subsets; the ensemble submodel selection and merging module 3025 is configured to merge outputs of the ensemble submodels to obtain predictive mill load parameters.

The soft sensing system 3 further includes the output unit 32 and the storage medium 33. Because of different configuration or function, the soft sensing system 3 can include one or more processors 302 and storages 301, one or more storage applications or storage medium 33 (for example on or more mass storage). The storage 301 and the storage medium 33 can be ephemeral or persistent. Moreover, the processor 302 can be communicated with the storage 301 and the storage medium 33 to execute a series of instructions of the storage 301 and the storage medium 33 in the system.

In some embodiments, the acquisition unit 31 includes a wireless receiving device 311 and a keyboard 312, where the wireless receiving device 311 obtains the shell vibration signals, the keyboard 312 is configured to input true mill load parameters for training the soft sensing system 3; the acquisition unit 31 further includes various sensors or other sensing devices installed on the ball mill for identifying and obtaining other process data.

In some embodiments, the output unit 32 includes a printer 321 and a monitor 322, which are configured to print and monitor the mill load parameters.

The soft sensing system 3 further includes one or more wired or wireless network interfaces 34, which are configured to obtain remote shell vibration and process data.

The soft sensing system 3 further includes one or more input or output interfaces 35, which can be a touch screen or input human feedback text messages via the keyboard 312.

The soft sensing system 3 further includes one or more operation system, such as Windows Server™, Mac OS X™, Unix™, Linux™ and FreeBSD™.

The acquisition unit 31, the processing unit 30 and the output unit 32 are communicated via the wired or wireless network interface 34 or the input or output interface 35 to read information and execute instructions.

From the above embodiments, those skilled in the art can clearly understand that the present invention can be implemented by software and necessary general hardware, and of course, the invention can also be implemented by dedicated hardware including dedicated integrated circuits, dedicated CPUs, dedicated storages and dedicated components. In general, all functions performed by computer programs can be easily implemented by corresponding hardware, and specific hardware for implementing the same function can also have diverse structures, such as analog circuits, digital circuits or dedicated circuits. However, it is preferable to implement the present invention with software programs in many cases. Such that, the technical solutions of the invention substantially or a part that contributes to existing techniques can be embodied in the form of a software product, which is stored in a readable storage medium, such as a computer floppy disk, a U disk, a mobile hard disk, a read-only memory (ROM, Read-Only Memory), a random access memory (RAM, Random Access Memory), a magnetic disk or an optical disk, and includes several instructions to let a computer device (a personal computer, a server or a network device, etc.) execute methods described in the embodiments of the invention.

Based on the soft sensing system 3, data of the mill under 5 working conditions are collected. The 5 working conditions include: a first experiment (B=292 kg, W=35 kg, M=25.5˜174 kg); a second experiment (B=340.69 kg, W=40 kg, M=29.7˜170.1 kg); a third experiment (B=389.36 kg, W=40 kg, M=34.2˜157.5 kg); a forth experiment (B=438.03 kg, W=35 kg, M=23.4˜151.2 kg) and a fifth experiment (B=486.7 kg, W=40 kg, M=15.3˜144.9 kg), where B, M, W represent steel ball, material and water load, respectively. All the above experiments are carried out under constant steel balls and water load, and a gradually increased ore load for 527 times.

First, time domain signals are filtered; then, data of stable rotation periods of the mill are converted to a frequency domain via the FFT technique to obtain a single-scale spectrum of multiple rotation periods of each channel; finally, these stable rotation periodic spectrum data are averaged to obtain a modelling spectrum with a final dimension of 12800. ⅘ of all samples are used as training and validation data sets for the modeling, and the rest are used for testing the model.

The experimental results are shown as follows.

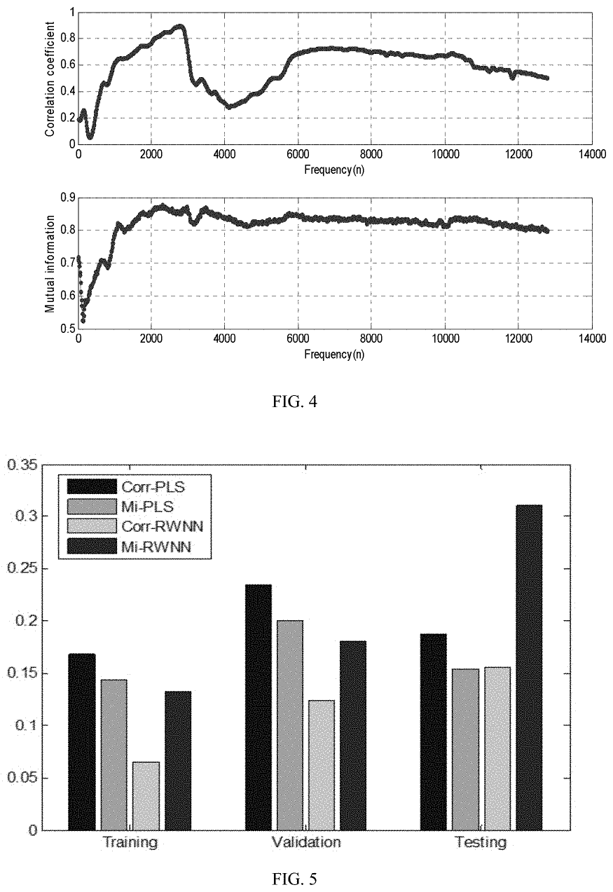

Based on 317 training data, correlation coefficients and mutual information values between the original spectrum features and the mill load parameters (the material to ball volume ratio MBVR) are shown in FIG. 4.

It can be concluded from FIG. 4 that there is difference between feature measurement results based on correlation coefficients and mutual information.

To verifying the method, selection coefficients of linear and nonlinear features are set to 1 and 1.5, respectively. Considering the effective range of a threshold, if 1.5 is larger than the maximum feature selection threshold, the threshold is automatically set to 0.99 times of the maximum feature selection coefficient to ensure a valid feature selection. Thereby, 2 linear feature subsets and 2 nonlinear feature subsets are selected.

Meanwhile, in the invention, a partial least squares algorithm suitable for high-dimensional collinear data modeling is selected as the linear modeling method, and a random weighted neural network with a fast modeling speed is selected as the nonlinear modeling method; and the number of latent variables of the partial least squares algorithm and the number of hidden layer nodes of the random weighted neural network are determined by the validation data.

4 feature subsets and 2 modelling methods are employed to merge 8 candidate submodels. For statistics convenience, a model coding is shown in Table 1.

TABLE 1
Coding schedule of submodel

| | | | | Feature |
|---|---|---|---|---|
| | | | | selection |
| | Submodel | Submodel | Submodel | coefficient |
| No. | feature | name | coding | of submodel |
| 1 | lin_ lin | Corr-PLS | 1-2 | 1-1.5 |
| 2 | nonlin_lin | Mi-PLS | 3-4 | 1-1.5 |
| 3 | lin_nonlin | Corr-RWNN | 5-6 | 1-1.5 |
| 4 | nonlin_nonlin | Mi-RWNN | 7-8 | 1-1.5 |

In Table 1, in the column “submodel feature”, a former term represents feature type, a consequent represents model type, the “lin” and “nonlin” represent linear and nonlinear, respectively; in the column “submodel name”, “Corr” and “Mi” represent correlation coefficient and mutual information, respectively, PLS and RWNN represent the partial least squares algorithm and the random weighted neural network respectively.

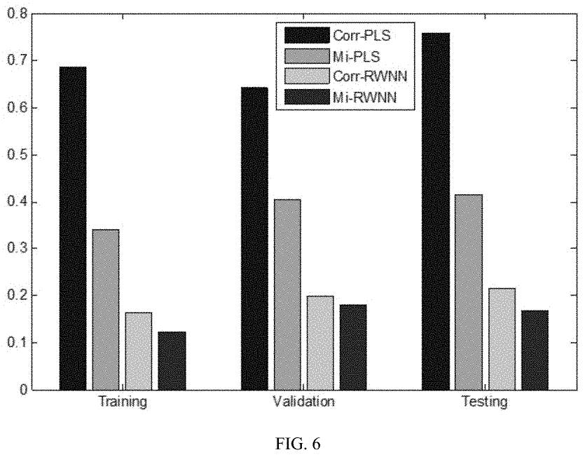

As shown in FIGS. 5 and 6, prediction error of different submodels when the correlation coefficient is 1 and 1.5, respectively.

As shown in FIG. 5, for MBVR, there is the smaller testing error between the linear submodel Mi-PLS established based on nonlinear features and the nonlinear submodel Corr-RWNN established based on linear features, meanwhile the nonlinear submodel Corr-RWNN of linear features has the smallest training error, linear submodel Corr-PLS of linear features has the largest training error, the nonlinear submodel Mi-RWNN of nonlinear features has the largest testing error.

As shown in FIG. 6, the nonlinear submodel Mi-RWNN of nonlinear features has the smallest testing, validation and training error, the nonlinear submodel Corr-RWNN established based on linear features has a lightly smaller prediction error than that of the nonlinear submodel Mi-RWNN of nonlinear features; linear submodel Corr-PLS of linear features has the largest testing, validation and training error, the linear submodel Mi-PLS established based on nonlinear features has a weaker performance.

It can be seen by comparing FIG. 5 with FIG. 6 that PLS models have stronger predictive performance when there are more features, but the situation is on the contrary for RWNN models. In conclusion, linear models require more features, and nonlinear models require less features.

The predictive error statistics of different submodels are shown in Table 2.

TABLE 2
Predictive error statistics of different submodels

| | | Corr-PLS | Mi-PLS | Corr-RWNN | Mi-RWNN |
|---|---|---|---|---|---|
| Feature | Training | 0.1686 | 0.1436 | 0.06447 | 0.1320 |
| selection | Validation | 0.2353 | 0.2001 | 0.1242 | 0.1802 |
| coefficient = | Testing | 0.1876 | 0.1540 | 0.1559 | 0.3109 |
| 1 | | | | | |
| Feature | Training | 0.6873 | 0.3405 | 0.1636 | 0.1233 |
| selection | Validation | 0.6423 | 0.4025 | 0.1968 | 0.1791 |
| coefficient = | Testing | 0.7599 | 0.4160 | 0.4160 | 0.1669 |
| 1.5 | | | | | |

An adaptive weighting algorithm is selected to calculate the weights of the above 8 submodels, and a branch-and-bound optimization algorithm is used to optimize the submodels in an ensemble size of 2-7. Submodels selected by the SEN predictive model and testing errors thereof are shown in Table 3, where “1” represents that the feature selection coefficient is 1 and “1.5” represents that the feature selection coefficient is 1.5.

TABLE 3
Submodels selected by the SEN predictive model in different
ensemble sizes and corresponding testing errors

| Ensemble | Submodel | | Testing | |
|---|---|---|---|---|
| size | No. | | error | Note |
| 2 | 5 | 3 | 0.1289 | 1-corr-RWNN, 1.5-Mi-PLS |

| | | | | | |
|---|---|---|---|---|---|
| 3 | 8 | 5 | 3 | 0.1176 | 1.5Mi-RWNN, . . . |

| 4 | 1 | 8 | 5 | 3 | 0.1250 | 1-Corr-PLS, . . . |
|---|---|---|---|---|---|---|
| 5 | 6 | 1 | 8 | 5 | 0.1188 | 1.5-Corr-RWNN, . . . |
| | 3 | | | | | |
| 6 | 7 | 6 | 1 | 8 | 0.1071 | 1-Mi-RWNN, . . . |
| | 5 | | 3 | | | |
| 7 | 4 | 7 | 6 | 1 | 0.1243 | 15-Mi-PLS |

| | | |
|---|---|---|
| 8 | 5 | 3 |

It can be seen from Table 3 that the SEN modelling strategy of different feature subsets and modelling methods for establishing MBVR predictive models are valid. When the ensemble size is 6, the testing error of the MBVR predictive model is 0.1071, which is less than 0.1540 and 0.1667, testing errors of optimal submodels when the correlation efficient is 1 and 1.5 in Table 2. In conclusion, the linear and nonlinear feature subsets, and the linear and nonlinear models are complementary.

To solve the problem of establishing an interpretable mapping model between multi-source high-dimensional data input features and difficult-to-measure parameters, this invention provides a soft sensing method for difficult-to-measure parameters in complex industrial processes. The main beneficial effects of the invention are as follows. The invention adaptively selects the linear feature subsets and nonlinear feature subsets according to the characteristics of the data, and provides a strategy of establishing linear feature linear submodels, linear feature nonlinear submodels, nonlinear feature linear submodels and nonlinear feature nonlinear submodels to enhance the diversity of the ensemble submodels. The invention is verified to be valid by establishing a soft sensing model for mill load parameters based on high-dimensional mechanical vibration spectrum data of a grinding process.

What is claimed is:

1. A soft sensing method for difficult-to-measure parameters in complex industrial processes, comprising:
rewriting input data X of a soft sensing model as follows:
$$\begin{matrix}X = [ {\{ {x}_{n}^{1} \}}_{n = 1}^{N} , L , {\{ {x}_{n}^{p} \}}_{n = 1}^{N} , L , {\{ {x}_{n}^{P} \}}_{n = 1}^{N} ] \\ = [ {x}^{1} , L , {x}^{p} , L , {x}^{P} ] \\ = {\{ {x}^{p} \}}_{p = 1}^{P} ;\end{matrix} \qquad ( 1 )$$
wherein N and P are the number and dimension of modelling samples, respectively, that is, P is the number of high-dimensional features of the input data, x^{p} represents a pth input feature; accordingly, the difficult-to-measure parameters are an output of the soft sensing model, expressed as y={yₙ}ₙ₋₁^{N};
performing a modelling strategy for establishing 4 modules comprising a linear feature selection module based on correlation coefficients, a nonlinear feature selection module based on mutual information, a candidate submodel establishment module and an ensemble submodel selection and merging module;
wherein {ξₗᵢₙ^{p}}ₚ₌₁^{P} represents correlation coefficients of all input features, ξₗᵢₙ^{p} represents a correlation coefficient of the pth input feature; {k_{linfea}^{j}^{ₗᵢₙ}}ⱼ_{ₗᵢₙ₌₁}^{J}^{ₗᵢₙ} represents a set of linear feature selection coefficients, k_{linfea}^{j}^{ₗᵢₙ} represents a jₗᵢₙth linear feature selection coefficient, Jₗᵢₙ represents the number of the linear feature selection coefficients, linear and nonlinear submodels of the linear features; θ_{linfea}^{j}^{ₗᵢₙ} represents a linear feature selection threshold determined based on the jₗᵢₙth linear feature selection coefficient k_{linfea}^{j}^{ₗᵢₙ}, {θ_{linfea}^{j}^{ₗᵢₙ}}ⱼ_{ₗᵢₙ₌₁}^{J}^{ₗᵢₙ} represents a set of all linear feature selection thresholds; X_{linfea}^{j}^{ₗᵢₙ} represents a linear feature subset selected based on the jₗᵢₙth linear feature selection threshold θ_{linfea}^{j}^{ₗᵢₙ}, {X_{linfea}^{j}^{ₗᵢₙ}}ⱼ_{ₗᵢₙ₌₁}^{J}^{ₗᵢₙ} represents a set of all linear feature subsets; {ξₙₒₙₗᵢₙ^{p}}ₚ₌₁^{P} represents mutual information of all original features, ξₙₒₙₗᵢₙ^{p} represents mutual information of the pth input feature; {k_{nonlinfea}^{j}^{ₙₒₙₗᵢₙ}}ⱼ_{ₙₒₙₗᵢₙ₌₁}^{J}^{ₙₒₙₗᵢₙ} represents a set of nonlinear feature selection coefficients, k_{nonlinfea}^{j}^{ₙₒₙₗᵢₙ} represents a jₙₒₙₗᵢₙth nonlinear feature selection coefficient; Jₙₒₙₗᵢₙ represents the number of the nonlinear feature selection coefficients, linear and nonlinear submodels of the nonlinear features; θ_{nonlinfea}^{j}^{ₙₒₙₗᵢₙ} represents a nonlinear feature selection threshold determined based on the jₙₒₙₗᵢₙth nonlinear feature selection coefficient k_{nonlinfea}^{j}^{ₙₒₙₗᵢₙ}, {θ_{nonlinfea}^{j}^{ₙₒₙₗᵢₙ}}ⱼ_{ₙₒₙₗᵢₙ₌₁}^{J}^{ₙₒₙₗᵢₙ} represents a set of all nonlinear feature selection thresholds; X_{nonlinfea}^{j}^{ₙₒₙₗᵢₙ} represents a nonlinear feature subset selected based on the jₙₒₙₗᵢₙth nonlinear feature selection threshold θ_{nonlinfea}^{j}^{ₙₒₙₗᵢₙ}, {X_{nonlinfea}^{j}^{ₙₒₙₗᵢₙ}}ⱼ_{ₙₒₙₗᵢₙ₌₁}^{J}^{ₙₒₙₗᵢₙ} represents a set of all nonlinear feature subsets; {f_{linMod}^{j}^{ₗᵢₙ}(⋅)}ⱼ_{ₗᵢₙ}₌₁^{J}^{ₗᵢₙ} and {ŷ_{linMod}^{j}^{ₗᵢₙ}}ⱼ_{ₗᵢₙ}₌₁^{J}^{ₗᵢₙ} represent a linear submodel subset of linear features and predictive outputs thereof, respectively, f_{linMod}^{j}^{ₗᵢₙ}(⋅) and ŷ_{linMod}^{j}^{ₗᵢₙ} represent a linear submodel of the jₗᵢₙth linear feature and a predictive output thereof, respectively; {f_{nonlinMod}^{j}^{ₗᵢₙ}(⋅)}ⱼ_{ₗᵢₙ}₌₁^{J}^{ₗᵢₙ} and {ŷ_{nonlinMod}^{j}^{ₗᵢₙ}}ⱼ_{ₗᵢₙ}₌₁^{J}^{ₗᵢₙ} represent a nonlinear submodel subset of linear features and predictive outputs thereof, respectively, f_{nonlinMod}^{j}^{ₗᵢₙ}(⋅) and ŷ_{nonlinMod}^{j}^{ₗᵢₙ} represent a nonlinear submodel of the jₗᵢₙth linear feature and a predictive output thereof, respectively; {f_{linMod}^{j}^{ₙₒₙₗᵢₙ}(⋅)}ⱼ_{ₙₒₙₗᵢₙ}₌₁^{J}^{ₙₒₙₗᵢₙ} and {ŷ_{linMod}^{j}^{ₙₒₙₗᵢₙ}}ⱼ_{ₗᵢₙ}₌₁^{J}^{ₗᵢₙ} represent a linear submodel subset of nonlinear features and predictive outputs thereof, respectively, f_{linMod}^{j}^{ₙₒₙₗᵢₙ}(⋅) and y_{linMod}^{j}^{ₙₒₙₗᵢₙ} represent a linear submodel of the jₙₒₙₗᵢₙth nonlinear feature and a predictive output thereof, respectively; {f_{nonlinMod}^{j}^{ₙₒₙₗᵢₙ}(⋅)}ⱼ_{ₙₒₙₗᵢₙ}₌₁^{J}^{ₙₒₙₗᵢₙ} and {ŷ_{nonlinMod}^{j}^{ₙₒₙₗᵢₙ}}ⱼ_{ₙₒₙₗᵢₙ}₌₁^{J}^{ₙₒₙₗᵢₙ} represent a nonlinear submodel subset of nonlinear features and predictive outputs thereof, respectively, f_{nonlinMod}^{j}^{ₙₒₙₗᵢₙ}(⋅) and ŷ_{nonlinMod}^{j}^{ₙₒₙₗᵢₙ} represent a nonlinear submodel of the jₙₒₙₗᵢₙth nonlinear feature and a predictive output thereof, respectively; {ŷ_{can}^{j}}ⱼ₌₁^{J} represents outputs of all candidate submodels, ŷ_{can}^{j} represents an output of a jₙₒₙₗᵢₙth candidate submodel, J represents the number of all candidate submodels; {ŷₛₑₗ^{j}^{ₛₑₗ}}ⱼ_{ₛₑₗ}₌₁^{J}^{ₛₑₗ} represents outputs of all ensemble submodels, ŷₛₑₗ^{j}^{ₛₑₗ} represents an output of a jₛₑₗth ensemble submodel, Jₛₑₗ represents the number of all ensemble submodels; and ŷ represents predictions of the difficult-to-measure parameters;
(1) linear feature selection based on correlation coefficients
calculating an absolute value of correlation coefficients of the high-dimensional features of the input data by taking a pth input feature x^{p}={xₙ^{p}}ₙ₌₁^{N} as an example according to the following equation:
$${ξ}_{lin}^{p} = \vert \frac{{\sum }_{n = 1}^{N} [ ( {x}_{n}^{p} - {\overline{x}}_{p} ) ( {y}_{n} - \overline{y} ) ]}{\sqrt{{\sum }_{n = 1}^{N} {( {x}_{n}^{p} - {\overline{x}}_{p} )}^{2}} \sqrt{{\sum }_{n = 1}^{N} {( {y}_{n} - \overline{y} )}^{2}}} \vert ; \qquad ( 2 )$$
wherein x̅ₚ and y̅ represent an average of N modelling samples of the pth input feature and the difficult-to-measure parameters, respectively; ξₗᵢₙ^{p} represents a correlation coefficient of the pth input feature;
obtaining the correlation coefficients {ξₗᵢₙ^{p}}ₚ₌₁^{P} of all input features by repeating the above calculation;
determining the linear feature selection threshold θ_{linfea}^{j}^{ₗᵢₙ} based on the jₗᵢₙth linear feature selection coefficient k_{linfea}^{j}^{ₗᵢₙ} according to the following equation:
$${θ}_{linfea}^{{j}_{lin}} = {k}_{linfea}^{{j}_{lin}} \cdot \frac{1}{P} {\sum }_{p = 1}^{P} {ξ}_{lin}^{p} ; \qquad ( 3 )$$
adaptively determining Jₗᵢₙ linear feature selection coefficients based on characteristics of the input data according to the following equation:
k_{linfea}^{j}^{ₗᵢₙ}=k_{linfea}^{min}:k_{linfea}^{step}:k_{linfea}^{max} (4);
wherein k_{linfea}^{min} and k_{linfea}^{max} represent a minimum and a maximum of k_{linfea}^{j}^{ₗᵢₙ}, respectively, and are calculated according to the following equations:
$$\begin{matrix}{k}_{linfea}^{min} = min ( {\{ {ξ}_{lin}^{p} \}}_{p = 1}^{P} ) / \frac{1}{P} {\sum }_{p = 1}^{P} {ξ}_{lin}^{p} ; & ( 5 ) \\ {k}_{linfea}^{max} = max ( {\{ {ξ}_{lin}^{p} \}}_{p = 1}^{P} ) / \frac{1}{P} {\sum }_{p = 1}^{P} {ξ}_{lin}^{p} ; & ( 6 )\end{matrix}$$
wherein min(⋅)and max(⋅)represent a minimum and a maximum, respectively; when k_{linfea}^{j}^{ₗᵢₙ} is 1, the linear feature selection threshold θ_{linfea}^{j}^{ₗᵢₙ} is an average;
k_{linfea}^{step} represents a step size of Jₗᵢₙ feature selection coefficients, and is calculated according to the following equation:
$${k}_{linfea}^{s t e p} = \frac{{k}_{linfea}^{max} - {k}_{linfea}^{min}}{{J}_{lin}} ; \qquad ( 7 )$$
selecting the input data by taking the pth input feature as an example based on the linear feature selection threshold θ_{linfea}^{j}^{ₗᵢₙ} according to the following equation:
$${α}_{{j}_{lin}}^{p} = \{ \begin{matrix}1 , & if & {ξ}_{l i n}^{p} \geq {θ}_{linfea}^{{j}_{lin}} \\ 0 , & else & {ξ}_{l i n}^{p} < {θ}_{linfea}^{{j}_{lin}}\end{matrix} ; \qquad ( 8 )$$
selecting variables when αⱼ_{ₗᵢₙ}^{p}=1 as linear features selected based on the linear feature selection threshold θ_{linfea}^{j}^{ₗᵢₙ}, preforming the above steps on all input features to obtain a linear feature subset X_{linfea}^{j}^{ₗᵢₙ}, indicated as follows:
X_{linfea}^{j}^{ₗᵢₙ}=[x¹,L ,x^{plinfea}^{^{jlin}},L ,x^{Plinfea}^{^{jlin}}] (9);
wherein x^{Plinfea}^{^{jlin}} represents a p_{linfea}^{j}^{ₗᵢₙ} feature in the linear feature subset X_{linfea}^{j}^{ₗᵢₙ}, p_{linfea}^{j}^{ₗᵢₙ}=1,L ,P_{linfea}^{j}^{ₗᵢₙ}, and P_{linfea}^{j}^{ₗᵢₙ} represents the number of all features in the linear feature subset X_{linfea}^{j}^{ₗᵢₙ}; and
indicating a set of all Jₗᵢₙ linear feature subsets as {X_{linfea}^{j}^{ₗᵢₙ}}ⱼ_{ₗᵢₙ₌₁}^{J}^{ₗᵢₙ};
(2) nonlinear feature selection based on mutual information
calculating the mutual information of the high-dimensional features of the input data by taking the pth input feature x^{p}={xₙ^{p}}ₙ₌₁^{N} as an example according to the following equation:
$${ξ}_{nonlin}^{p} = {\sum }_{n = 1}^{N} {\sum }_{n = 1}^{N} {p}_{r o b} ( {x}_{n}^{p} , {y}_{n} ) log ( \frac{{p}_{r o b} ( {x}_{n}^{p} , {y}_{n} )}{{p}_{r o b} ( {x}_{n}^{p} ) {p}_{rob} ( {y}_{n} )} ) ; \qquad ( 10 )$$
wherein p_{rob}(xₙ^{p},yₙ) represents a joint probability density, p_{rob}(xₙ^{p}) and p_{rob}(yₙ) represent marginal probability densities;
^{P}
repeating the above calculation to obtain the mutual information {ξₙₒₙₗᵢₙ^{p}}ₚ₌₁^{P} of all input features;
determining the nonlinear feature selection threshold θ_{nonlinfea}^{j}^{ₙₒₙₗᵢₙ} based on the jₙₒₙₗᵢₙth nonlinear feature selection coefficient k_{nonlinfea}^{j}^{ₙₒₙₗᵢₙ} according to the following equation:
$${θ}_{nonlinfea}^{{j}_{nonlin}} = {k}_{nonlinfea}^{{j}_{nonlin}} \cdot \frac{1}{P} {\sum }_{p = 1}^{P} {ξ}_{nonlin}^{p} ; \qquad ( 11 )$$
adaptively determining Jₙₒₙₗᵢₙ nonlinear feature selection coefficients based on characteristics of the input data according to the following equation:
k_{linfea}^{j}^{ₙₒₙₗᵢₙ}=k_{linfea}^{min}:k_{linfea}^{step}:k_{linfea}^{max} (12);
wherein k_{nonlinfea}^{min} and k_{nonlinfea}^{max} represent a minimum and a maximum of k_{linlinfea}^{j}^{ₙₒₙₗᵢₙ}, respectively, and are calculated according to the following equations:
$$\begin{matrix}{k}_{nonlinfea}^{min} = min ( {\{ {ξ}_{nonlin}^{p} \}}_{p = 1}^{P} ) / \frac{1}{P} {\sum }_{p = 1}^{P} {ξ}_{nonlin}^{p} ; & ( 13 ) \\ {k}_{nonlinfea}^{max} = max ( {\{ {ξ}_{nonlin}^{p} \}}_{p = 1}^{P} ) / \frac{1}{P} {\sum }_{p = 1}^{P} {ξ}_{nonlin}^{p} ; & ( 14 )\end{matrix}$$
wherein when k_{linlinfea}^{j}^{ₙₒₙₗᵢₙ} is 1, the nonlinear feature selection threshold θ_{nonlinfea}^{j}^{ₙₒₙₗᵢₙ} is an average;
k_{nonlinfea}^{step} represents a step size of Jₙₒₙₗᵢₙ feature selection coefficients, and is calculated according to the following equation:
$${k}_{nonlinfea}^{s t e p} = \frac{{k}_{nonlinfea}^{max} - {k}_{nonlinfea}^{min}}{{J}_{nonlin}} ; \qquad ( 15 )$$
selecting the input data by taking the pth input feature as an example based on the nonlinear feature selection threshold θ_{nonlinfea}^{j}^{ₙₒₙₗᵢₙ} according to the following equation:
$${α}_{{j}_{nonlin}}^{p} = \{ \begin{matrix}1 , & if & {ξ}_{nonlin}^{p} \geq {θ}_{nonlinfea}^{{j}_{nonlin}} \\ 0 , & else & {ξ}_{nonlin}^{p} < {θ}_{nonlinfea}^{{j}_{nonlin}}\end{matrix} ; \qquad ( 16 )$$
selecting variables when αⱼ_{ₙₒₙₗᵢₙ}^{p}=1 as nonlinear features selected based on the nonlinear feature selection threshold θ_{nonlinfea}^{j}^{ₙₒₙₗᵢₙ} , preforming the above steps on all input features to obtain a nonlinear feature subset X_{nonlinfea}^{j}^{ₙₒₙₗᵢₙ}, indicated as follows:
X_{nonlinfea}^{j}^{ₙₒₙₗᵢₙ}=[x¹,L ,x^{pnonlinfea}^{^{jnonlin}},L ,x^{Pnonlinfea}^{^{jnonlin}}] (17);
wherein x^{Pnonlinfea}^{^{jnonlin}} represents a p_{nonlinfea}^{j}^{ₙₒₙₗᵢₙ} feature in the nonlinear feature subset X_{nonlinfea}^{j}^{ₙₒₙₗᵢₙ}, p_{nonlinfea}^{j}^{ₙₒₙₗᵢₙ}=1,L ,P_{nonlinfea}^{j}^{ₙₒₙₗᵢₙ} represent the number of all features in the nonlinear feature subset X_{nonlinfea}^{j}^{ₙₒₙₗᵢₙ}; and
indicating a set of all Jₙₒₙₗᵢₙ nonlinear feature subsets as {X_{nonlinfea}^{j}^{ₙₒₙₗᵢₙ}}ⱼ_{ₙₒₙₗᵢₙ₌₁}^{J}^{ₙₒₙₗᵢₙ};
(3) candidate submodel establishment
When establishing linear submodels of linear features using a linear modelling algorithm based on jₗᵢₙth linear feature subset, indicating inputs and outputs thereof as the following equation:
ŷ_{linMod}^{j}^{ₗᵢₙ}=f_{linMod}^{j}^{ₗᵢₙ}(X_{linfea}^{j}^{ₗᵢₙ}) (18);
performing the above step on all linear feature subsets to obtain the linear submodel subset of linear features {f_{linMod}^{j}^{ₗᵢₙ}(⋅)}ⱼ_{ₗᵢₙ}₌₁^{J}^{ₗᵢₙ} and the predictive outputs {ŷ_{linMod}^{j}^{ₗᵢₙ}}ⱼ_{ₗᵢₙ}₌₁^{J}^{ₗᵢₙ} thereof;
wherein when establishing nonliner submodels of linear features using a nonlinear modelling algorithm based on jₗᵢₙth linear feature subset, indicating inputs and outputs thereof as the following equation:
y_{nonlinMod}^{j}^{ₗᵢₙ}=f_{nonlinMod}^{j}^{ₗᵢₙ}(X_{linfea}^{j}^{ₗᵢₙ}) (19);
performing the above step on all linear feature subsets to obtain the nonlinear submodel subset of linear features {f_{nonlinMod}^{j}^{ₗᵢₙ}(⋅)}ⱼ_{ₗᵢₙ}₌₁^{J}^{ₗᵢₙ} and the predictive outputs {y_{nonlinMod}^{j}^{ₗᵢₙ}}ⱼ_{ₗᵢₙ}₌₁^{J}^{ₗᵢₙ} thereof;
wherein the two above submodel subsets adopt the same linear features as inputs and obtain different predictive outputs using different modelling algorithms;
when establishing linear submodels of nonlinear features using a linear modelling algorithm based on jₙₒₙₕₙth nonlinear feature subset, indicating inputs and outputs thereof as the following equation:
ŷ_{linMod}^{j}^{ₙₒₙₗᵢₙ}=f_{linMod}^{j}^{ₙₒₙₗᵢₙ}(X_{nonlinfea}^{j}^{ₙₒₙₗᵢₙ}) (20);
performing the above step on all nonlinear feature subsets to obtain the linear submodel subset of nonlinear features {f_{linMod}^{j}^{ₙₒₙₗᵢₙ}(⋅)}ⱼ_{ₙₒₙₗᵢₙ}₌₁^{J}^{ₙₒₙₗᵢₙ} and the predictive outputs {ŷ_{linMod}^{j}^{ₙₒₙₗᵢₙ}}ⱼ_{ₙₒₙₗᵢₙ}₌₁^{J}^{ₙₒₙₗᵢₙ} thereof;
when establishing nonlinear submodels of nonlinear features using a nonlinear modelling algorithm based on jₙₒₙₗᵢₙth nonlinear feature subset, indicating inputs and outputs thereof as the following equation:
ŷ_{nonlinMod}^{j}^{ₙₒₙₗᵢₙ}=f_{nonlinMod}^{j}^{ₙₒₙₗᵢₙ}(X_{nonlinfea}^{j}^{ₙₒₙₗᵢₙ}) (21);
performing the above step on all nonlinear feature subsets to obtain the nonlinear submodel subset of nonlinear features {f_{linMod}^{j}^{ₙₒₙₗᵢₙ}(⋅)}ⱼ_{ₙₒₙₗᵢₙ}₌₁^{J}^{ₙₒₙₗᵢₙ} and the predictive outputs {ŷ_{linMod}^{j}^{ₙₒₙₗᵢₙ}}ⱼ_{ₙₒₙₗᵢₙ}₌₁^{J}^{ₙₒₙₗᵢₙ} thereof;
wherein the two above submodel subsets adopt the same nonlinear features as inputs and obtain different predictive outputs using different modelling algorithms;
(4) ensemble submodel selection and merging
merging the predictive outputs of the 4 submodels according to the following equation:
{ŷ_{can}^{j}}ⱼ₌₁^{J}=[{ŷ_{linMod}^{j}^{ₗᵢₙ}}ⱼ_{ₗᵢₙ}₌₁^{J}^{ₗᵢₙ}, {ŷ_{nonlinMod}^{j}^{ₗᵢₙ}}ⱼ_{ₗᵢₙ}₌₁^{J}^{ₗᵢₙ}, {ŷ_{linMod}^{j}^{ₙₒₙₗᵢₙ}}ⱼ_{ₙₒₙₗᵢₙ}₌₁^{J}^{ₙₒₙₗᵢₙ}, {ŷ_{nonlinMod}^{j}^{ₙₒₙₗᵢₙ}}ⱼ_{ₙₒₙₗᵢₙ}₌₁^{J}^{ₙₒₙₗᵢₙ}] (22);
wherein J=2Jₗᵢₙ+2Jₙₒₙₗᵢₙ, J is the number of all 4 submodels and also the number of candidate submodels;
selecting predictive outputs of Jₛₑₗ ensemble submodels from predictive outputs of J candidate submodels using an optimization algorithm, and merging the predictive outputs of Jₛₑₗ ensemble submodels to obtain an output of a final SEN prediction model according to a selected merging algorithm:
$$\{ \begin{matrix}\hat{y} = {f}_{SEN} ( {\{ {\hat{y}}^{{j}_{sel}} \}}_{{j}_{sel} = 1}^{{J}_{sel}} ) \\ {\{ {\hat{y}}^{{j}_{sel}} \}}_{{j}_{sel} = 1}^{{J}_{sel}} ∈ {\{ {\hat{y}}^{j} \}}_{j = 1}^{J}\end{matrix} ; \qquad ( 23 )$$
wherein f_{SEN}(⋅) is an algorithm for merging the predictive outputs of Jₛₑₗ ensemble submodels, Jₛₑₗ is also an ensemble size of selective integrated models;
to solve the above problem, first selecting the merging algorithm for predictive outputs of ensemble submodels, then optimizing Jₛₑₗ ensemble submodels using an optimization algorithm based on a root mean square error RMSE of minimizing the SEN model, and merging these ensemble submodels, finally obtaining the SEN prediction model with the ensemble size of Jₛₑₗ;
wherein the algorithm f_{SEN}(⋅) for merging the predictive outputs of Jₛₑₗ ensemble submodels comprises the following 2 types:
a first type which calculates weighting coefficients, that is, obtains SEN output according to the following equation:
$$\hat{y} = {f}_{S E N} ( {\{ {\hat{y}}^{{j}_{sel}} \}}_{{j}_{sel} = 1}^{{J}_{sel}} ) = {\sum }_{{j}_{sel} = 1}^{{J}_{sel}} {w}^{{j}_{sel}} {\hat{y}}^{{j}_{sel}} ; \qquad ( 24 )$$
wherein w^{j}^{ₛₑₗ} represents a weighting coefficient of a jₛₑₗth ensemble submodel, and
$${\sum }_{{j}_{sel}}^{{J}_{sel}} {w}^{{j}_{sel}} = 1 ;$$
a second type which establishes a mapping relation between the ensemble submodels and the SEN model using linear and nonlinear regression modelling methods.

2. The method of claim 1, wherein the method is applied to modelling for internal mill load parameters based on a high-dimensional shell vibration spectrum of an experimental ball mill in an experiment; in the experiment, a vibration acceleration sensor fixed on a surface of a mill shell is configured to collect data of different working conditions, and at least one of B, M and W is different therebetween, wherein B, M and W represent steel ball, material and water load, respectively; first, time domain signals are filtered; then, data of stable rotation periods of the mill are converted to a frequency domain via the FFT technique to obtain a single-scale spectrum of multiple rotation periods of each channel; finally, these stable rotation periodic spectrum data are averaged to obtain a modelling spectrum with a final dimension of 12800; part of all samples are used as training and validation data sets for the modeling, and the rest are used for testing the model.

3. The method of claim 1, wherein the selection coefficients of linear and nonlinear features are set to 1 and 1.5, respectively.
